(19) United States
(12) Patent Application Publication
(10) Pub. No.: US 2011/0115923 A1
(43) Pub. Date: May 19, 2011

(54) DIGITAL CAMERA CONNECTED TO A COMPUTER USING RFID AUTHENTIFICATION

(75) Inventor: Kazuo Moritomo, Kawasaki-shi (JP)

(73) Assignee: CANON KABUSHIKI KAISHA, Tokyo (JP)

(21) Appl. No.: 12/863,420

(22) PCT Filed: Mar. 24, 2009
(86) PCT No.: PCT/JP2009/056423

§ 371 Date: Jul. 16, 2010

(30) Foreign Application Priority Data
Apr. 1, 2008 (JP) 2008-095435

(51) Int. Cl. H04N 5/225; H04Q 5/22

(52) U.S. Cl. 348/207.1; 340/10.1; 348/E05.024

(57) ABSTRACT

A wireless communication apparatus having a first wireless communication unit for performing RFID communication and a second wireless communication unit for performing data transfer executes authentication processing by providing authentication information using communication by the first wireless communication unit, and detects the result of authentication processing. Data transfer using the second wireless communication unit is allowed if authentication success is detected by the authentication processing, and supply of power for the second wireless communication unit is stopped if authentication failure is detected.

### TECHNICAL FIELD

The present invention relates to a wireless communication terminal having a function for sending and receiving signals by, for example, so-called “contactless communication”.

### BACKGROUND ART

Contactless IC cards that incorporate an RFID (Radio-Frequency Identification) circuit take advantage of the ability to readily access a device and have recently become widespread as railroad passenger tickets.

There is also a contactless data transfer technique referred to as “TransferJET”. This transfer technique requires a supply of power and although it has a maximum communication distance of only a short 3 cm, it features a very high speed of 560 Mbps. Installing “TransferJET” in devices such as notebook personal computers, mobile telephones, digital cameras and printers would make possible high-speed communication with these devices and enhance user convenience.

Although data transfer can be performed easily with the contactless transfer technique, security management is a concern. Accordingly, Japanese Patent Laid-Open No. 2006-221452 proposes the following authentication technique: Assume that there is an authentication terminal having a short-range wireless communication function and a mobile terminal having a sensing function for sensing an authentication terminal that exists within a prescribed zone. When a first start condition such as a key input has been established at the mobile terminal in a state in which personal identity has not yet been authenticated, the mobile terminal searches for a nearby authentication terminal and carries out authentication. If authentication succeeds, then a transition is made to a state in which personal identity has been authenticated, thereby making it possible to operate the mobile terminal.

However, the problem set forth below arises with this method.

For example, it is predicted that devices such as notebook personal computers, digital cameras and printers equipped with contactless transfer technology will appear on the market. Assume a case where the notebook personal computer is primarily a device for inputting data, that the digital camera is primarily a device for transferring data and that processing for transferring image data from within the digital camera to the notebook personal computer by data transfer is executed. Since these devices will each be equipped with an interface that relies upon contactless transfer technology, it will be possible to execute data transfer easily merely by holding the digital camera over the notebook personal computer or placing the digital camera on the notebook personal computer. In other words, this scheme skips the phase in which confirmation is made of the user's intent to execute processing as is often performed with password verification. This means that although anyone can acquire the image data from within the digital camera simply and quickly, the problem of security arises in terms of handling the image data.

### DISCLOSURE OF INVENTION

The present invention has been devised in view of the foregoing problem and seeks to provide wireless communication for performing contactless transfer, such wireless communication providing enhanced security without sacrificing the user-friendliness that is a feature of contactless transfer.

According to one aspect of the present invention, there is provided a wireless communication apparatus comprising: first wireless communication means for providing authentication information; second wireless communication means for performing data transfer; determination means for determining success/failure of authentication processing based upon the authentication information provided by the first wireless communication means; and control means for executing data transfer using the second wireless communication means if it is determined by the determination means that authentication by the authentication processing has succeeded, and halting supply of power to the second wireless communication means if it is determined by the determination means that authentication by the authentication processing has failed.

According to another aspect of the present invention, there is provided a method of controlling a wireless communication apparatus having first wireless communication means for providing authentication information and second wireless communication means for performing data transfer, the method comprising: a determination step of determining success/failure of authentication processing based upon the authentication information provided by the first wireless communication means; and a control step of executing data transfer using the second wireless communication means if it is determined at the determination step that authentication by the authentication processing has succeeded, and halting supply of power to the second wireless communication means if it is determined at the determination step that authentication by the authentication processing has failed.

According to still another aspect of the present invention, there is provided a wireless communication system for transferring data from a first wireless communication apparatus to a second wireless communication apparatus, the system comprising: first wireless communication means for performing communication of authentication information between the first wireless communication apparatus and the second wireless communication apparatus; second wireless communication means for performing data transfer between the first wireless communication apparatus and the second wireless communication apparatus; authentication processing means for performing authentication processing between the first wireless communication apparatus and the second wireless communication apparatus by communication of the authentication information using the first wireless communication means; transfer means for executing data transfer using the second wireless communication means if it is determined that authentication by the authentication processing means has succeeded; and control means for halting supply of power to the second wireless communication means in the first wireless communication apparatus if it is determined that authentication by the authentication processing means has failed.

According to yet another aspect of the present invention, there is provided a method of controlling a wireless communication system having first wireless communication means for performing communication of authentication information between a first wireless communication apparatus and a second wireless communication apparatus, and second wireless communication means for performing data transfer between the first wireless communication apparatus and the second wireless communication apparatus, the system transferring data from the first wireless communication apparatus to the second wireless communication apparatus, the method comprising: an authentication processing step of performing authentication processing between the first wireless communication apparatus and the second wireless communication apparatus by communication of the authentication information using the first wireless communication means; a transfer step of executing data transfer using the second wireless communication means if it is determined that authentication at the authentication processing step has succeeded; and a control step of halting supply of power to the second wireless communication means in the first wireless communication apparatus if it is determined that authentication at the authentication processing step has failed.

Further features of the present invention will become apparent from the following description of exemplary embodiments with reference to the attached drawings.

### BRIEF DESCRIPTION OF DRAWINGS

FIG. 1 is a diagram illustrating an example of the configuration of a wireless communication system;

FIG. 2 is a block diagram illustrating an example of the functional configuration of a DSC;

FIG. 3 is a block diagram illustrating an example of the functional configuration of a personal computer;

FIG. 4 is a flowchart illustrating processing for transferring wireless data by a DSC 101;

FIG. 5 is a flowchart illustrating unlock processing executed by a DSC 101; and

FIG. 6 is a flowchart illustrating processing for transferring wireless data by personal computer 102.

### DESCRIPTION OF THE EMBODIMENT

A preferred embodiment of the present invention will now be described with reference to the accompanying drawings.

Objects and features of this embodiment are as set forth below. Specifically, a wireless terminal according to the present invention is equipped with an RFID function as a first wireless communication unit for authentication purposes. It is further equipped with a short-range contactless communication function (referred to as a “wireless data communication function” below), which requires a power supply different from that of the RFID, as a second wireless communication unit for the purpose of data communication. The wireless terminal is capable of maintaining the security of handled data while preserving ease of data transfer.

The wireless system used in the description of this invention is composed of a digital-still camera (“DSC” below) having the RFID function and wireless data communication function, and a notebook personal computer having similar functions. The system is such that transfer of data (image data in this embodiment) that takes security into account is implemented between the DSC and notebook personal computer merely by holding the DSC over the notebook personal computer.

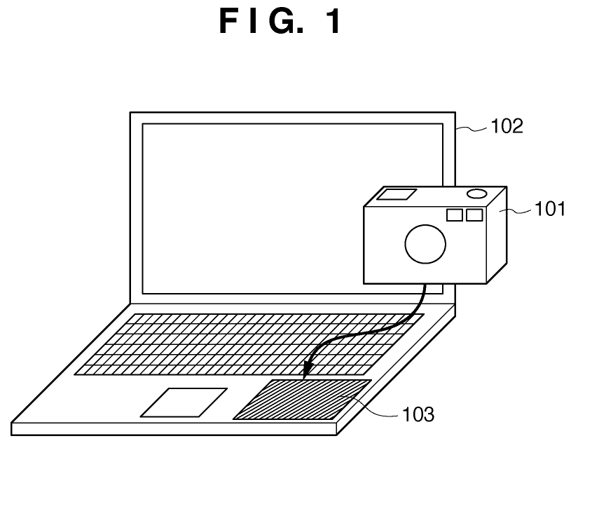

FIG. 1 is a diagram illustrating an example of the configuration of a system in a wireless terminal according to this embodiment.

A DSC 101 has an RFID functional unit that implements wireless communication for the purpose of authentication, and a wireless data communication functional unit that implements wireless communication for data transfer by supplying power. The RFID functional unit in the DSC 101 mainly comprises an IC chip with antenna worked into the form of a tag or label and functions as an “RFID tag” for storing information in the chip.

A personal computer 102 is a notebook personal computer (“personal computer” below) which similarly has an RFID functional unit that implements wireless communication for the purpose of authentication, and a wireless data communication functional unit that implements wireless communication for data transfer. The RFID functional unit in the personal computer 102 functions mainly as a “reader/writer” for writing and reading information to and from the RFID tag.

An interface 103 for a short-range contactless communication function (an interface for wireless data communication) implements authentication or data transceive via the RFID reader/writer and wireless data communication unit in response to the DSC 101 being held over it. It may be so arranged that the interface for a short-range contactless communication function is provided separately and is connected to the personal computer 102 via an interface such as USB.

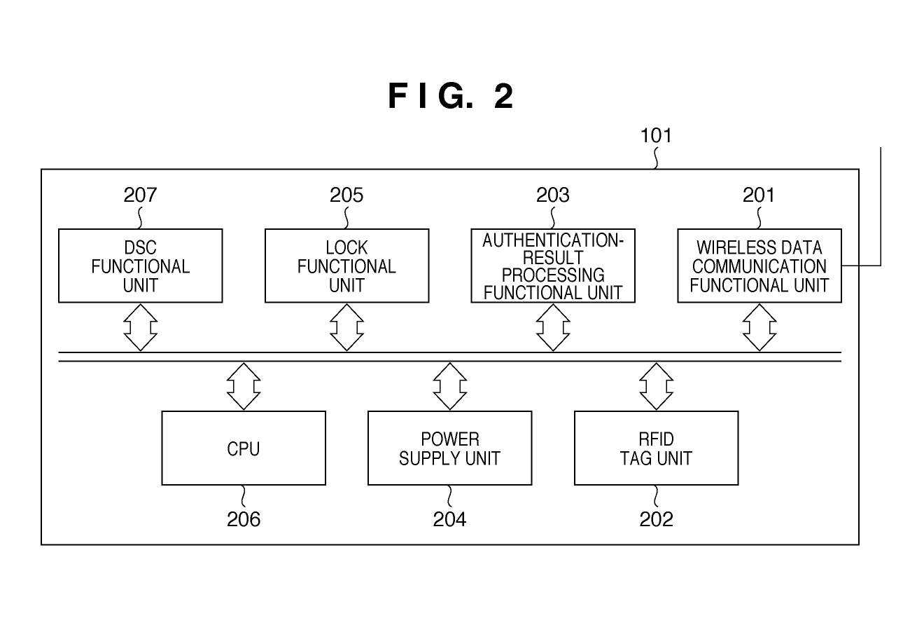

The configuration of the DSC 101 will be described first. FIG. 2 is a block diagram illustrating an example of the functional configuration of the DSC 101 in this embodiment.

A wireless data communication functional unit 201 is a block which, by being supplied with power from a power supply unit 204, implements wireless communication for data transfer described above. This block sends and receives wireless signals to and from another wireless communication device.

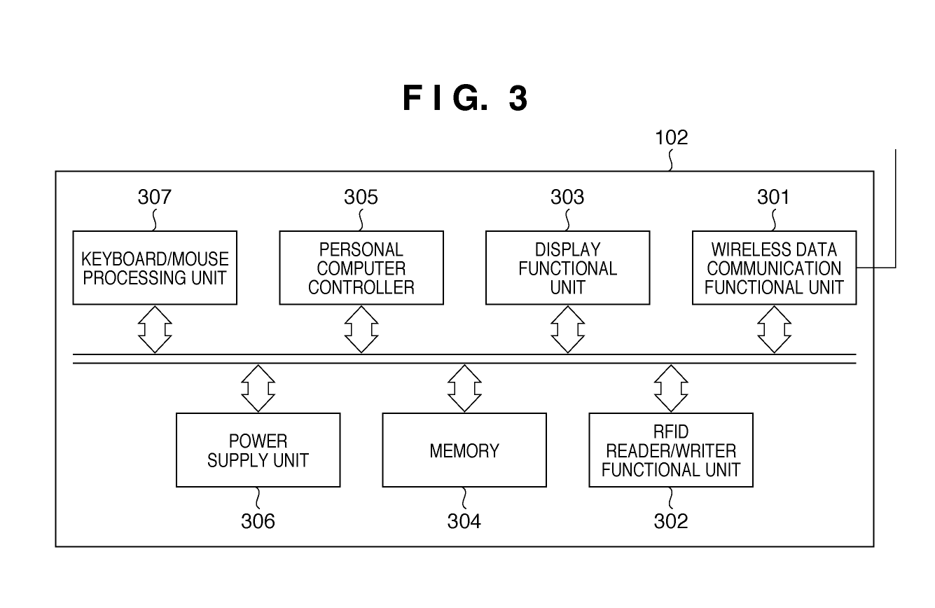

An RFID tag unit 202 is used in order to implement wireless communication for authentication purposes as described above. For example, authentication information can be written by an RFID reader/writer functional unit 302 (described later with reference to FIG. 3) in the personal computer 102. The wireless system of this embodiment is such that authentication processing is implemented by verifying information, which has been written to the RFID, using the RFID reader/writer functional unit 302 of personal computer 102.

An authentication-result processing functional unit 203 executes suitable processing in accordance with the result of authentication reported from the RFID tag unit 202. Further, this unit executes condition determination for unlocking the DSC 101 from the locked state. The details of this processing will be described later.

A power supply unit 204 supplies driving power to the blocks that require supply of power, such as a DSC functional unit 207, the wireless data communication functional unit 201 and a CPU 206.

A lock functional unit 205 halts supply of power to the wireless data communication functional unit 201 in accordance with a command from the authentication-result processing functional unit 203 and, further, locks the DSC functional unit 207 against operation.

The CPU 206 is a block for commanding and controlling the foregoing operations.

The DSC functional unit 207 is a block for actually implementing such functions of the DSC as image sensing.

The configuration of the personal computer 102 will be described next. FIG. 3 is a block diagram illustrating an example of the functional configuration of the personal computer 102 in this embodiment.

A wireless data communication functional unit 301 is a block for implementing the above-mentioned wireless communication for data transfer by being supplied with power from a power supply unit 306. This block sends and receives wireless signals to and from another wireless communication device.

The RFID reader/writer functional unit 302 is used in authentication processing as set forth above.

A display functional unit 303 is a monitor for presenting various displays on the personal computer 102. A memory 304 stores various data and a control program by which the CPU (not shown) of the personal computer 102 executes various processing.

A personal computer controller 305 has a CPU (not shown) and controls the operation of each block.

The power supply unit 306 supplies power to each block within the personal computer 102.

A keyboard/mouse processing unit 307 controls inputs from a keyboard and controls the operation of a pointing device (a mouse in this example).

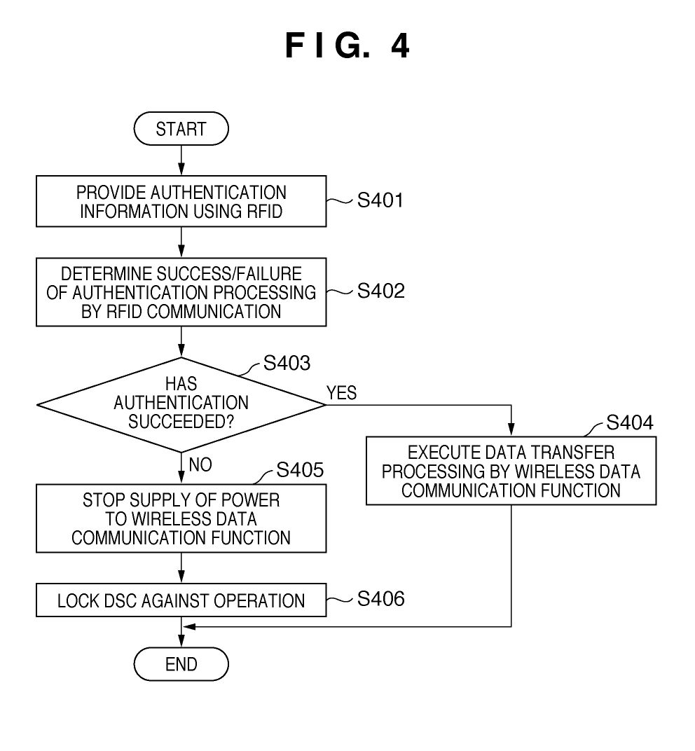

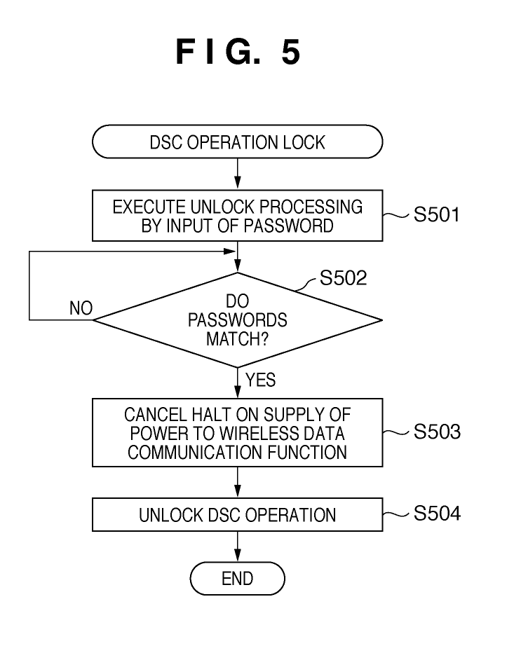

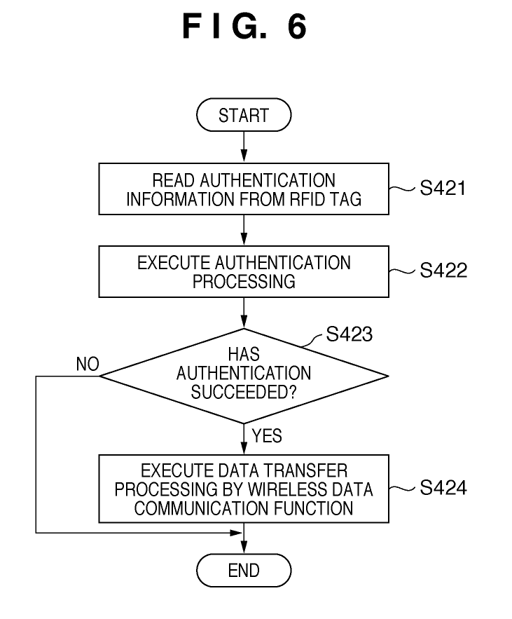

The devices that constitute the wireless system of FIG. 1 are as described above. In the system of FIG. 1, a method of use is conceivable in which still-image data and moving-image data that has been stored in the DSC 101 is loaded into the personal computer 102 merely by holding the DSC 101 over the personal computer 102. Also conceivable is a method of use in which still-image data and moving-image data that has been stored in the DSC 101 is output to the display functional unit 303 of personal computer 102 merely by holding the DSC 101 over the personal computer 102. No problems arise in a case where a data transfer from the DSC 101 to the personal computer 102 intended by the user is carried out. However, a data transfer between devices not intended by the user, for example, data transfer in a case where the personal computer 102 is a personal computer prepared by a malicious third party, must be blocked. The specific method will be described below using the flowcharts of FIGS. 4 to 6. FIG. 4 is a flowchart illustrating processing for transferring wireless data executed in the DSC 101. FIG. 5 is a flowchart illustrating unlock processing executed by the DSC 101 to cancel a locked state. FIG. 6 is a flowchart illustrating processing for transferring wireless data executed in the personal computer 102.

The user places the DSC 101 on the interface 103 of the personal computer 102 for the short-range contactless communication function or holds the DSC 101 over the interface 103 and brings it close enough to enable communication, as illustrated in FIG. 1. By virtue of this operation, communication by RFID is performed between the RFID tag unit 202 and the RFID reader/writer functional unit 302 (step S401). The RFID reader/writer functional unit 302 in the personal computer 102 executes authentication processing based upon authentication information that has been read from the RFID tag unit 202 (steps S421, S422). Authentication processing between the DSC 101 and personal computer 102 is thus executed. The personal computer 102 starts communication of data using the wireless data communication functional unit 301 and wireless data communication functional unit 201 only in a case where authentication succeeds (steps S423, S424). Accordingly, after communication by the RFID tag unit 202 is executed, the CPU 206 in the DSC 101 is capable of judging whether authentication has succeeded or not by determining whether data communication by the wireless data communication functional unit 201 has started within a prescribed period of time (step S402). The start of data communication can be judged by receiving a data-communication request from the personal computer 102. Furthermore, it may be so arranged that success or failure of authentication processing is judged upon accepting information indicating authentication success or failure from the personal computer 102 via the wireless data communication functional unit 201.

It is necessary that some authentication information be written into the RFID tag unit 202 of DSC 101 by the RFID reader/writer functional unit 302 of personal computer 102, as mentioned above. For example, it is deemed that authentication processing has succeed by having the RFID reader/writer functional unit 302 of personal computer 102 make a comparison with the authentication information that has been written to the RFID tag unit 202 of the DSC101 and then verifying that there is a match between the items of authentication information. In this embodiment, data transfer processing between the DSC 101 and a personal computer 102 not intended by the user, namely a personal computer 102 for which authentication processing does not succeed, will be described. Accordingly, it will be assumed that authentication information for which authentication processing by the RFID reader/writer functional unit 302 of personal computer 102 will not succeed has been written to the RFID tag unit 202 of DSC 101, or that no authentication information has been written to the RFID tag unit 202.

If it is determined that authentication processing has succeeded, then the authentication-result processing functional unit 203 starts data transfer processing by the wireless data communication functional unit 201 of DSC 101 and by the wireless data communication functional unit 301 of personal computer 102 (steps S403, S404). If it is determined that authentication processing has failed, on the other hand, then processing proceeds from step S403 to step S405. It should be noted that in making the determination that authentication processing has failed, it may be so arranged that the failure determination is not rendered after only a single time in order to take into consideration a case where the user has performed an erroneous operation. That is, it may be so arranged that the determination that authentication processing has failed is made after authentication fails a predetermined prescribed number of times in succession. Upon receiving the result of failure of authentication processing, the authentication-result processing functional unit 203 stops the supply of power, which is supplied from the power supply unit 204 to the wireless data communication functional unit 201, via the lock functional unit 205 (step S405).

In recent DSCs, even though the main power supply in the camera body may be turned off, power continues to be supplied to some of the blocks from the power supply unit 204. Depending upon the device, therefore, there are cases where even if the main power supply in the camera body is turned off, data transfer to a personal computer, or the like, is still possible because power is being supplied to the wireless data communication functional unit 201. Accordingly, the goal of the processing of step S405 includes the inhibiting of such data transfer as well.

Furthermore, acting through the lock functional unit 205, the authentication-result processing functional unit 203 locks the camera against operation in order to reject manipulation of the DSC 101 (step S406). For example, the authentication-result processing functional unit 203 rejects manipulation of the DSC 101 with the exception of an operation that is for unlocking the locked state. This processing makes it possible to inhibit other data transfer functions using a USE cable or the like and to prevent the erasure of image data within the DSC 101.

The above-described processing makes it possible to prevent data transfer by a short-range contactless communication function unintended by the user.

Described next will be a cancellation method for a case where the DSC 101 has been locked against operation by the lock functional unit 205 due to authentication processing with an unauthorized personal computer or erroneous operation by the user. The DSC 101 in the locked state requests unlock processing in response to any operation of the camera by the user. For example, a display prompting input of authentication data (e.g., a password) for unlocking the camera is presented on the monitor, or the like, of the DSC in the DSC functional unit 207 even in cases where a playback button or shoot button is pressed (step S501). Any well-known technique such as a jog dial or soft keyboard can be employed as the user interface for performing alphanumeric input. The DSC 101 compares the password entered by the user and an already set password by using the authentication-result processing functional unit 203 (step S502). If the result of the comparison is that the two passwords match, then, acting through the lock functional unit 205, the authentication-result processing functional unit 203 cancels the halt on the supply of power to the wireless data communication function (step S503) and unlocks the camera from the operationally locked state (step S504).

Thus, the DSC 101 executes authentication processing with the personal computer 102 using the RFID tag in the manner described above. The DSC 101 performs a normal data transfer if authentication processing succeeds and halts supply of power from the camera power supply to the wireless data communication function if authentication processing fails. Furthermore, if authentication processing fails, the DSC 101 is locked against various user operations (i.e., operations other than a password-input operation for the purpose of unlocking the camera from the locked state).

By virtue of these functions, simple data transfer can be provided while maintaining security in a device having a short-range contactless communication function.

The present invention is also achievable in embodiments such as a system, an apparatus, a method, a program, or a storage medium. Specifically, it may also be applied to a system constituted by multiple devices and may also be applied to an apparatus constituted by a single device.

Note that the case where the functionality of the abovementioned embodiment is achieved by directly or remotely supplying a software program to a system or device and reading out and executing the supplied program code through a computer in the system or device is included in the scope of the present invention. In this case, the supplied program is a computer program that corresponds to the flowchart indicated in the drawings in the embodiment.

Accordingly, the program code itself, installed in a computer so as to realize the functional processing of the present invention through a computer, also realizes the present invention. In other words, the computer program itself, for realizing the functional processing of the present invention, is also included within the scope of the present invention.

In this case, object code, a program executed through an interpreter, script data supplied to an OS, or the like may be used, as long as it has the functions of the program.

Examples of the a computer readable storage medium that can be used to supply the computer program include Floppy® disks, hard disks, optical disks, magneto-optical disks, MOs, CD-ROMs, CD-Rs, CD-RWs, magnetic tape, non-volatile memory cards, ROMs, and DVDs (DVD-ROMs, DVD-Rs).

Using a browser of a client computer to connect to an Internet homepage and downloading the computer program of the present invention to a storage medium such as a hard disk can be given as another method for supplying the program. In this case, the downloaded program may be a compressed file including a function for automatic installation. Furthermore, this method may be realized by dividing the program code that makes up the program of the present invention into a plurality of files and downloading each file from different homepages. In other words, a WWW server that allows a plurality of users to download the program files for realizing the functional processing of the present invention through a computer also falls within the scope of the present invention.

Furthermore, the program of the present invention may be encrypted, stored in a storage medium such as a CD-ROM, and distributed to users. In this case, a user that has cleared a predetermined condition is allowed to download key information for removing the cryptography from a homepage via the Internet, use the key information to decrypt the program, and install the program on a computer.

Also, the functions of the present embodiment may be realized, in addition to through the execution of a loaded program using a computer, through cooperation with an OS or the like running on the computer based on instructions of the program. In this case, the OS or the like performs part or all of the actual processing, and the functions of the above-described embodiment are realized by that processing.

Furthermore, part or all of the functionality of the aforementioned embodiment may be written into a memory provided in a function expansion board installed in the computer, a function expansion unit connected to the computer, or the like, into which the program read out from the storage medium is written. In this case, after the program has been written into the function expansion board or the function expansion unit, a CPU or the like included in the function expansion board or the function expansion unit performs part or all of the actual processing based on the instructions of the program.

While the present invention has been described with reference to an exemplary embodiment, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-095435, filed Apr. 1, 2008, which is hereby incorporated by reference herein in its entirety.

1. A wireless communication apparatus comprising:
first wireless communication means for providing authentication information;
second wireless communication means for performing data transfer;
determination means for determining success/failure of authentication processing based upon the authentication information provided by said first wireless communication means; and
control means for executing data transfer using said second wireless communication means if it is determined by said determination means that authentication by the authentication processing has succeeded, and halting supply of power to said second wireless communication means if it is determined by said determination means that authentication by the authentication processing has failed.

2. The apparatus according to claim 1, further comprising lock means for placing the wireless communication apparatus in a locked state, in which operation of the wireless communication apparatus is rejected, if the authentication processing has failed.

3. The apparatus according to claim 1, wherein said determination means determines that authentication has failed if the authentication processing has failed a predetermined number of times in succession.

4. The apparatus according to claim 2, further comprising acceptance means for accepting input of authentication data, which is for canceling the locked state, while in the locked state.

5. A method of controlling a wireless communication apparatus having first wireless communication means for providing authentication information and second wireless communication means for performing data transfer, said method comprising:
a determination step of determining success/failure of authentication processing based upon the authentication information provided by the first wireless communication means; and
a control step of executing data transfer using the second wireless communication means if it is determined at said determination step that authentication by the authentication processing has succeeded, and halting supply of power to said second wireless communication means if it is determined at said determination step that authentication by the authentication processing has failed.

6. The method according to claim 5, further comprising a locking step of placing the wireless communication apparatus in a locked state, in which operation of the wireless communication apparatus is rejected, if the authentication processing has failed.

7. A wireless communication system for transferring data from a first wireless communication apparatus to a second wireless communication apparatus, said system comprising:
first wireless communication means for performing communication of authentication information between the first wireless communication apparatus and the second wireless communication apparatus;
second wireless communication means for performing data transfer between the first wireless communication apparatus and the second wireless communication apparatus;
authentication processing means for performing authentication processing between the first wireless communication apparatus and the second wireless communication apparatus by communication of the authentication information using the first wireless communication means;
transfer means for executing data transfer using the second wireless communication means if it is determined that authentication by said authentication processing means has succeeded; and
control means for halting supply of power to said second wireless communication means in the first wireless communication apparatus if it is determined that authentication by said authentication processing means has failed.

8. A method of controlling a wireless communication system having first wireless communication means for performing communication of authentication information between a first wireless communication apparatus and a second wireless communication apparatus, and second wireless communication means for performing data transfer between the first wireless communication apparatus and the second wireless communication apparatus, said system transferring data from the first wireless communication apparatus to the second wireless communication apparatus, said method comprising:
an authentication processing step of performing authentication processing between the first wireless communication apparatus and the second wireless communication apparatus by communication of the authentication information using the first wireless communication means;
a transfer step of executing data transfer using the second wireless communication means if it is determined that authentication at said authentication processing step has succeeded; and
a control step of halting supply of power to said second wireless communication means in the first wireless communication apparatus if it is determined that authentication at said authentication processing step has failed.

9. A computer-readable storage medium storing a control program for causing a computer to execute the control method set forth in claim 5.
